(19) United States
(12) Patent Application Publication
(10) Pub. No.: US 2022/0328968 A1
(43) Pub. Date: Oct. 13, 2022

(54) ALL METAL MODULAR ARRAY

(71) Applicant: BAE Systems Information and Electronic Systems Integration, Inc., Nashua, NH (US)

(72) Inventors: Alexander D. Johnson, Waltham, MA (US); Randall R. Lapierre, Hooksett, NH (US)

(73) Assignee: BAE Systems Information and Electronic Systems Integration, Inc., Nashua, NH (US)

(21) Appl. No.: 17/224,624

(22) Filed: Apr. 7, 2021

(51) Int. Cl. H01Q 9/16; H01Q 1/42; H01Q 1/48; H01Q 21/00

(52) U.S. Cl. CPC H01Q 9/16; H01Q 1/422; H01Q 1/48; H01Q 21/0025

(57) ABSTRACT

An all-metal antenna element with integrated common mode rejection realized with an all-metal fabrication and a balanced feed. Further, the present disclosure may provide an all-metal antenna element which may extend the bandwidth of the aperture, allow for simple linear frequency and platform scalability, and may improve the compatibility of arrays to modern digital phased array chains.

### TECHNICAL FIELD

The present disclosure relates to modular antennas and antenna arrays. More particularly, in one example, the present disclosure relates to a modular ultra-wideband differential antenna array. Specifically, in another example, the present disclosure relates to a modular all-metal ultra-wideband differential antenna array with an integrated common mode rejection realized with an all-metal fabrication.

### BACKGROUND

Wide band antennas and arrays are essential for high-resolution radar and tracking systems, high data rate communication links, and multi-waveform, multi- function front ends. Various array technologies have been developed that are capable of wideband or ultra-wideband operation (up to 10:1 or more) and may provide a large field of view; however, many existing designs are limited by their electrical thickness, scanning performance, or use of lossy materials. Many of these antennas and arrays are variants of the tightly coupled dipole array (TCDA) which are low profile and efficient with wide bandwidth, good scan performance, and low cross polarization. TCDAs typically include a cluster of closely spaced dipole elements extending from a ground plane. Most of these antennas have many interdependent design features requiring a highly skilled designer to tune the implementation thereof towards application-specific requirements.

TCDAs have demonstrated large impedance bandwidths and scanning performance in a low profile of (λ_{High}/2). These ultra-wide bandwidth (UWB) arrays are extensions of the Current Sheet Array (CSA) concept. The first CSAs achieved 4:1 bandwidth by introducing capacitive coupling between antenna elements to counter the effect of ground plane inductance. Additional bandwidth was later achieved by introducing integrated wideband printed balun feeds to be optimized along with the dipole elements. Such TCDA with integrated feeds have been demonstrated to extend bandwidths, reduce size by more than half, and cut weight by a factor of 5, all with an order of magnitude cost reduction. Further optimizations of the TCDA were addressed to increase impedance bandwidths up to 46:1 via substrate loading, scan down to 80° through Frequency Selective Surface (FSS) superstrates, and operate at millimeter-wave frequencies.

These types of past TCDAs employ wideband single-ended (unbalanced) feeds, but these feeds are not suited for the close integration required for digital phased arrays (DPAs). The latter is important as future integrated transceivers are likely to be differential to accompany the balanced transmission lines on the RF side of integrated transceiver chips. The major challenge in the design of a full differential radio is the reduction of the common mode currents that can exist at the aperture and in between the ports that feed the aperture. These common mode currents can greatly reduce the impedance bandwidth. Indeed, differential feeds have been proposed in the past, but they are narrowband with limited scanning capability. Therefore, most past arrays have employed only single-ended feeds to achieve wideband scanning. However, these single-ended feeds suffer from distortions introduced by noise from common-mode, power supplies, or general electromagnetic interference (EMI), drastically affecting antenna performance. One exemplary TCDA that was designed to overcome these challenges is taught in U.S. Pat. No. 10,320,088.

A notable technique is to use unbalanced feeds with shorting posts to mitigate common mode resonances, resulting in 5:1 bandwidth after external impedance matching has been discussed as a Planar Ultrawideband Modular Antenna (PUMA) Array. The PUMA Array is fabricated with planar etched circuits and plated vias, thus it can be fabricated as a multilayer microwave printed circuit board (PCB), and does not require external baluns. The PUMA array consists of a dual- offset dual-polarized version of tightly-coupled dipoles above a ground plane, fed by unbalanced feed-line scheme. The PUMA Array has shorting vias at its dipole arms, enabling direct connection to standard RF interfaces and modular construction. The placement of the plated vias controls the frequency of a catastrophic common mode that would otherwise occur near mid-band since the array is fed unbalanced.

In the PUMA Array, the dipole elements, ground plane, and dielectric layers provide wideband performance, based upon the current sheet principle; however, the feed and dipole arrangements of the PUMA array are unique inasmuch as it requires the unbalanced feed. The unbalanced feed lines are utilized without exciting the catastrophic common-mode resonance found in 2D unbalanced fed arrays. More importantly, this feeding method avoids “cable organizers,” since the unbalanced feed lines do not support the scan-induced common-modes typical of balanced fed arrays. This allows the entire PUMA Array (radiating elements and feed lines) to be fabricated as a single microwave multilayer PCB, with the feed lines and shorting posts implemented as plated vias. Also, the unbalanced feed lines in the PUMA Array connect to standard 50Ωinterfaces (coax, stripline, microstrip, CPW, etc.) without an external balun. An additional advantage derived from the unbalanced feed arrangement and the dual-offset, dual-polarized offset (egg-crate) lattice is modularity. As PUMA array modules can be formed by intersecting planes passing between the feed line vias, therefore a PUMA Array can be built and assembled modularly.

Another notable technique involves an all-metal array that is scalable in both frequency and volume which has been discussed as a Frequency-scaled Ultra- wide Spectrum Element (FUSE) array. The FUSE array is fabricated using all-metal additive manufacturing to make a wideband, active electronically scanned array (AESA); however, the FUSE array still utilizes a single-ended feed. While the all- metal fabrication allows for scalability, the single ended feed FUSE array still suffers from distortions introduced by noise from common-mode, power supplies, or general electromagnetic interference (EMI), as mentioned above, and further suffers from additional losses due to an extraneous balun in the chain.

Each of these types of TCDAs provide certain benefits in certain applications; however, there is typically a trade-off in features when switching between such arrays. For example, as mentioned above, a highly-skilled designer is required to tune these TCDAs and their many interdependent design features for applications-specific requirements. Thus, one particular TCDA may be highly suited for one application, for example, an expanded or extended bandwidth of the aperture; however, the tradeoff is perhaps, for example, a reduction in platform scalability and/or compatibility of that particular TCDA to modern DPA chains. Similarly, other TCDAs may be scalable and readily compatible; however, may suffer from narrower bandwidth of the aperture.

Thus, current TCDAs are highly application-specific requiring highly- skilled designers and are further not easily scalable and/or compatible across varying platforms and/or varying applications. The typical construction of current TCDAs tends to increase the cost to manufacture as they utilize multiple materials and multiple manufacturing processes. Further, existing TCDAs utilizing single-ended feeds are not typically compatible with many modern DPAs, meaning, unnecessary losses are realized in the element-integrated balun and then again further down the chain.

### SUMMARY

Although the aforementioned PUMA and FUSE arrays have some advantages, there still exists a need for a TCDA that does not use balun and/or single ended feed. One particular need exists when differential signals (i.e., balanced) signals are fed/input into the antenna. This need has arisen inasmuch as the PUMA and FUSE arrays require unbalanced/single ended feeds/inputs. The present disclosure addresses this need by providing a differential (i.e., balanced) feed all-metal modular antenna element, or all-metal modular array (AMMA), with integrated common mode rejection realized with an all-metal fabrication and a balanced feed with two shorted dipole arms and an achievable Bandwidth ratio greater than 10:1 without added loss. Additionally, the AMMA may extend the bandwidth of the aperture, allow for simple linear frequency and platform scalability, and may improve the compatibility of arrays to modern digital phased array (DPA) chains.

The present disclosure also relates generally to the configuration and operation of an antenna feed for a TCDA. Typically, TCDAs have high potential and have a high bandwidth potential; however, to meet that potential, there needs to be a feed that is able to excite the antenna across its bandwidth and match impedance with low losses and high efficiency. During operation of a TCDA, each antenna element is a dipole which is inherently differential, meaning it has a positive and a negative terminal.

Operatively, TCDAs are wideband antennas that cover many frequencies. This is advantageous for many applications because they can perform more than one function at one time with a single aperture. Because of this wideband feature, there must be a feed that is efficient to provide the power to the TCDA. First, power must be injected into the antenna. The feed injects the power in an efficient and wideband manner.

During conventional operation, the dipole in a TCDA must be balanced. Each dipole therefor has a positive node and a negative node. The positive node and the negative node are referenced to each other. The dipoles may be fed in a variety of different ways. For example, previous teachings of the Tightly Coupled Dipole Array with Integrated Balun (TCDA-IB) utilized a Marchand balun to feed it from the single-ended input to the dipole's differential. The reason for this configuration will allow improved beam steering. Particularly, this configuration eliminates E-plane scan resonance. The use of the Marchand balun mitigates the E-plane resonance that occurs with the most basic differential feeds. However, there are some operative drawbacks with using this type of configuration. Namely, the use of the Marchand balun changes the nature of the signal so that it does not have a positive and a negative. The use of a Marchand balun results in a positive and a ground. The downside of this configuration is that it has a reduced performance and does not maintain linearity over the bandwidth (i.e. it is non-symmetric). The use of one balun often requires that additional baluns be added to the configuration later; however, TCDAs typically want to maintain differential but this requires the antenna system to account for common mode resonance. Thus, since it is advantageous to keep the differential, the present disclosure presents an operative configuration of a TCDA that has a differential feed but reduces or eliminates common mode resonance that are E- plane resonances that need to be mitigated. The existence of common mode resonance reduces the scanning ability of the TCDA; thus, it is advantageous to reduce the common mode resonance so as to maintain the scanning capabilities of the TCDA.

In accordance with an aspect of the present disclosure, the AMMA of the present disclosure takes advantage of a differential or balanced feed configuration without the need for a balun.

In accordance with an exemplary aspect of the present disclosure, one embodiment utilizes a short or conductive element that shorts the common mode resonance. Shorting the common mode resonance in an intentional manner removes instances of the common mode resonance. In a common mode, the phases of the input signals are facing the same direction. When the currents and phases are the same, it results in electromagnetic radiation; however, it is desirable to not have the feed become impeded by radiation in the feed, or by coupling with adjacent elements. Thus, it is desirable to not have the feed line radiate and only transmit the power to the dipole elements. To achieve the shorting of the common mode resonance, a conductive element is connected with the dipole arms and connected to the ground plane of the array. This creates a loop that pushes the resonance out of the band of interest.

In one aspect, an exemplary embodiment of the present disclosure may provide a modular antenna unit comprising: a differential feed input operable to receive a differential signal; at least one antenna element having a first arm and a second arm; a first differential feed line having a first end in electrical connection with a first dipole on the first arm and a second end in electrical connection with the differential feed input; a second differential feed line having a first end in electrical connection with a second dipole on the second arm and a second end in electrical connection with the differential feed input; a common ground plane; a first shorting arm having a first end in electrical connection with the first dipole on the first arm and a second end in electrical connection with the common ground plane; and a second shorting arm having a first end in electrical connection with the second dipole on the second arm and a second end in electrical connection with the common ground plane, wherein the first and second shorting arms are adapted to short a portion of the differential signal from the first and second dipoles to the common ground plane. This exemplary embodiment or another exemplary embodiment may further provide wherein the at least one antenna element further comprises: a first antenna element having a first arm and a second arm; and a second antenna element having a first arm and a second arm. This exemplary embodiment or another exemplary embodiment may further provide wherein the first antenna element further comprises: a vertically polarized antenna element. This exemplary embodiment or another exemplary embodiment may further provide wherein the second antenna element further comprises: a horizontally polarized antenna element, wherein the second antenna element is arranged orthogonally to the first antenna element. This exemplary embodiment or another exemplary embodiment may further provide wherein the antenna unit further comprises: a plurality of unit cells with each cell of the plurality of unit cells having a first antenna element and a second antenna element. This exemplary embodiment or another exemplary embodiment may further provide wherein the plurality of unit cells are adjoined by the common ground plane. This exemplary embodiment or another exemplary embodiment may further provide wherein the at least one antenna element, first and second feed lines, ground plane, and first and second shorting arms are formed from a single continuous piece of material. This exemplary embodiment or another exemplary embodiment may further provide wherein the single continuous piece of material further comprises: a conductive metal surface. This exemplary embodiment or another exemplary embodiment may further provide wherein the single continuous piece of material is 3- D printed. This exemplary embodiment or another exemplary embodiment may further provide at least one overlap layer further defining a radome. This exemplary embodiment or another exemplary embodiment may further provide a plurality of overlap layers further defining the radome.

In another aspect, an exemplary embodiment of the present disclosure may provide a method comprising: generating a differential antenna signal; feeding a first portion of the differential signal having a first phase to a positive terminal on an antenna element of a modular antenna unit, wherein the modular antenna unit does not include a balun; feeding a second portion of the differential signal having a second phase that is opposite of the first phase to a negative terminal on the antenna element of the modular antenna unit; transmitting at least some of the differential signal through a feed line to a dipole on the antenna element and radiating the at least some of the differential signal outwardly from the dipole; and mitigating common mode resonance in the modular antenna unit with a shorting arm in electrical connection with the dipole and the ground plane. This exemplary embodiment or another exemplary embodiment may further provide wherein mitigating common mode resonance further comprises: shorting at least some of the differential signal from the dipole to a ground plane via the shorting arm. This exemplary embodiment or another exemplary embodiment may further provide wherein feeding the first and second portions of the differential signal to an antenna element further comprises: feeding the first portion of the differential signal having the first phase to a positive terminal on a plurality of antenna elements of a modular antenna unit; and feeding the second portion of the differential signal having the second phase to a negative terminal on the plurality of antenna elements of a modular antenna unit. This exemplary embodiment or another exemplary embodiment may further provide wherein the plurality of antenna elements are electrically connected to the ground plane. This exemplary embodiment or another exemplary embodiment may further provide wherein mitigating common mode resonance in the modular antenna unit further comprises: mitigating common mode resonance in the modular antenna unit with a shorting arm in electrical connection with a dipole on each of the antenna elements of the plurality of antenna elements and the ground plane. This exemplary embodiment or another exemplary embodiment may further provide wherein mitigating common mode resonance further comprises: shorting at least some of the differential signal from the dipole on each of the antenna elements of the plurality of antenna elements to the ground plane via the shorting arm. This exemplary embodiment or another exemplary embodiment may further provide forming the modular antenna unit from a single continuous piece of material. This exemplary embodiment or another exemplary embodiment may further provide wherein forming the modular antenna unit further comprises: forming the modular antenna unit from a single continuous piece of conductive metal material. This exemplary embodiment or another exemplary embodiment may further provide wherein forming the modular antenna unit further comprises: 3-D printing the modular antenna unit from a single continuous piece of conductive metal material.

### BRIEF DESCRIPTION OF THE SEVERAL VIEWS OF THE DRAWINGS

Sample embodiments of the present disclosure are set forth in the following description, are shown in the drawings and are particularly and distinctly pointed out and set forth in the appended claims.

FIG. 1 is a top isometric perspective view of a 3x3subarray according to one aspect of the present disclosure.

FIG. 2 is a top isometric perspective exploded view of a 3x3subarray with radome/superstrate overlaps according to one aspect of the present disclosure.

FIG. 3 is a top isometric perspective view of a 1x1unit cell of a modular array according to one aspect of the present disclosure.

FIG. 4 is a diagrammatic view of e-plane scan resonances in differential feed lines.

FIG. 5 is an exemplary flow chart depicting a method of operation for a modular array according to one aspect of the present disclosure.

Similar numbers refer to similar parts throughout the drawings.

### DETAILED DESCRIPTION

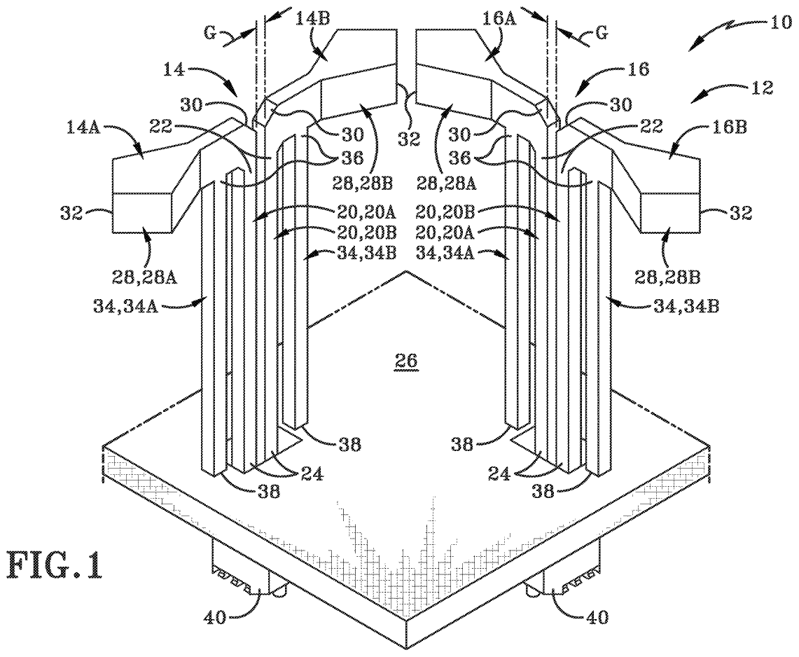

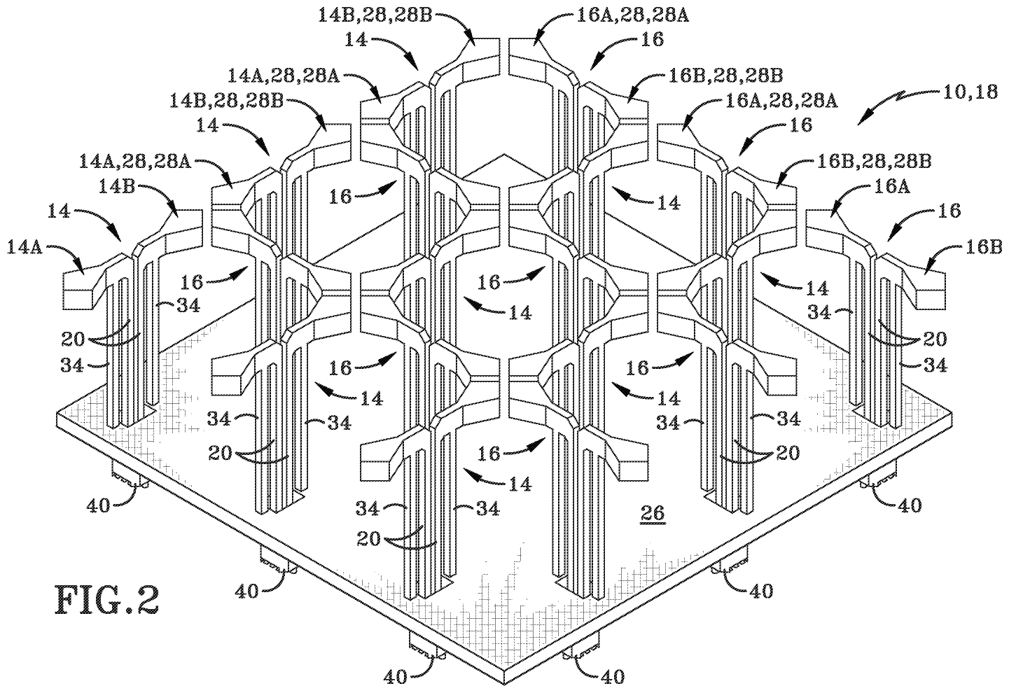

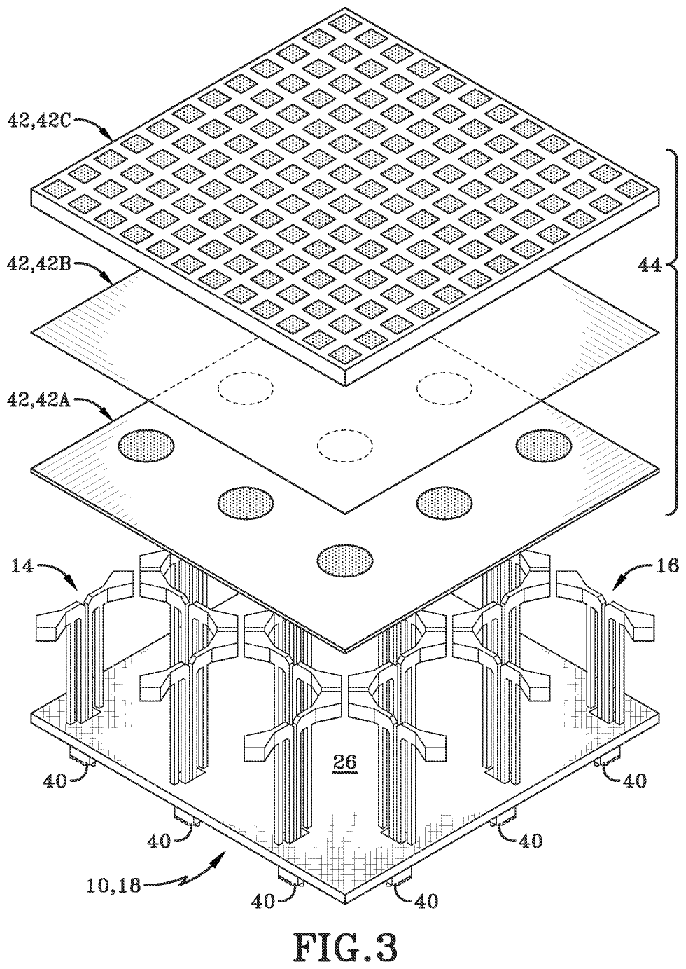

With general reference to FIGS.1-3, a modular array of the present disclosure is shown and generally indicated at reference 10. While shown in FIG.1 as a 1x1 unit cell (reference 12) and in FIGS.2 and 3 as a 3x3 subarray (reference 18), it will be understood that modular array 10 could be any size and configuration as dictated by the desired implementation. Accordingly, as used herein, modular array 10 is understood to refer generally to the array and array components and may be of any size and configuration, as discussed further below.

Modular array 10 may be constructed of a plurality of single unit cells 12 which may be a modular unit having a first antenna element 14 and a second antenna element 16. As discussed further herein, elements 14 and 16 may be polarized with one of these elements being vertically polarized (v-pol) and the other being horizontally polarized (h-pol). As used herein, first element 14 may be the v-pol element and second element 16 may be the h-pol element; however it will be understood that either element may be positioned and/or polarized as desired and dictated by the specific implementation thereof. According to one aspect, array 10 is contemplated to be an all-metal fabrication. Therefore, array 10 may be constructed of any suitable, conductive metal, including any suitable alloys thereof. According to one aspect, array 10 may be constructed using any suitable additive or subtractive manufacturing process, including, but not limited to, 3-D printing, casting, CNC, or the like. Further according to this aspect, array 10 may be constructed as a single continuous unit or structure. According to another aspect, individual components of array 10 may be constructed separately and assembled, if desired. According to another aspect, array 10 may be constructed of any suitable material which may be encased in, coated with, or otherwise covered with a conductive material, such as a conductive metal or the like to provide a conductive metal surface. According to one non-limiting example, array 10 may include a plastic core with a conductive surface coating thereon.

Each unit cell 12 may scalable in that unit cells may be measured on any suitable or desirable scale. For example, each unit cell 12 may be 1cm x 1cm, 1in x 1in, 1m x 1m, etc. Alternatively, modular array may be fabricated as a subarray 18 having multiple elements and of any size/configuration. One such example is the 3x3 subarray 18 shown in FIGS.2 and 3. As with unit cells 12, subarrays 18 may be scalable, i.e. measured on any suitable scale. For example, a 3x3 subarray 18 may be 3cm x 3cm, 3in x 3in, 3m x 3m, etc. Further, as unit cells 12 and subarrays 18 are modular, multiple cells 12 and/or subarrays 18 may be combined and connected to form larger or more complex configurations. For example, a 3x3 subarray 18 may be combined with another 3x3 subarray 18 to form a 3x6 modular array 10. According to another example, a 3x3 subarray 18 may be joined to three 1x1 unit cells 12 on one side thereof to form a 3x4 modular array 10. It will be understood that combining multiple cells 12 and/or subarrays 18 may be employed to configure modular array 10 into any desired size and/or configuration.

Both unit cells 12 and subarrays 18 may include first and second antenna elements 14 and 16 (with subarrays 18 having a plurality thereof which may be arranged in a grid or grid-like fashion, as best seen in FIGS.2 and 3). Each of these elements 14 and 16 may be substantially similar but for their placement, orientation, and/or polarization. For example, as discussed further below, first element 14 may have a first polarization and second element 16 may have a second polarization and may be arranged orthogonally relative to first element 14. Where a plurality of elements 14 and 16 are present, as in subarray 18 or the like, each element 14 and 16 may be orthogonal relative to the adjacent element to form the grid or grid-like pattern seen in FIGS.2 and 3. According to another aspect, elements 14 and 16 may be oriented in any suitable position relative to each other and may further have overlapping portions or shared components where desirable.

Each antenna element 14 and 16 may include have a first arm 14A, 16A and a second arm 14B, 16B which may be substantially similar but for their orientation. Specifically, first arms 14A, 16A may have mirror imaged symmetry with second arms 14B, 16B, respectively. For purposes of simplicity and clarity, the remaining components of elements 14 and 16 will be described with reference to first element 14 (and both arms 14A and 14B thereof), but will be understood to be applicable to second element 16 (and both arms 16A and 16B thereof) unless specifically stated otherwise.

Both first and second arms 14A and 14B may include an integrated feed line 20 with a first end 22 and a second end 24 spaced vertically apart therefrom. Feed line 20 may pass through the integrated ground plane 26 (discussed further below) such that first end 22 of feed line 20 is above the ground plane 26 and second end 24 is below the ground plane 26. Feed line 20 may be formed of any suitable conductive metal as desired. Feed line 20 of first arm 14A may be a first feed line 20A and feed line 20 of second arm 14B may be a second fee line 20B. Together, first and second feed lines 20A and 20B may form a simple twin feed line 20 arrangement.

Feed line 20A of first arm 14A may be connected to or in electrical connection with feed line 20B of second arm 14B, as dictated by the desired implementation. Feed lines 20A and 20B may further define a pair of differential feed lines.

Each of arms 14A and 14B may further include a dipole 28 (28A and 28B, respectively) located at or near the first end 22 of feed line 20 and extending perpendicularly thereto. Dipoles 28 may have generally have a first end 30 terminating at or substantially at the first end 22 of feed line 20 and in electrical connection therewith. Dipoles 28 may further have a second end 32 spaced horizontally apart from first end 30. First end 30 of the dipole 28A on first arm 14A may be horizontally separated from the first end 30 of the dipole 28A on second arm 14B such that the dipoles 28A and 28B may extend away from one another. This space between dipoles 28A and 28B on first and second arms 14A and 14B is indicated as gap G in FIG.1. This gap G may similarly represent the space between feed line 20A on first arm 14A and feed line 20B on second arm 14B and may substantially define a vertical centerline of each element 14 about which the arms 14A and 14B may have the aforementioned mirror imaged symmetry.

Arms 14A and 14B may each be “shorted” to the ground plane 26 by shorting arms 34 (with shorting arm 34A connected to first arm 14A and shorting arm 34B connected to second arm 14B) which may have a first end 36 in electrical connection with dipole 28 and a second end 38 in electrical connection with ground plane 26. Shorting arms 34 may be common mode mitigation elements which are conductive elements or conductors that electrically couples the dipoles 28 to the ground plane 26.

As mentioned previously herein, array 10 may include a common ground plane 26 that is electrically connected to each of the antenna elements 14 and 16. The ground plane 26 is an electrical ground that may enable a portion of the signal to be shorted thereto, as discussed above with regards to shorting arms 34. The common ground plane 26 may assist in eliminating common mode signals or common mode resonance, as discussed further below.

Ground plane 26 may extend outwardly and generally perpendicularly relative to first and second elements 12 and 16 and may additionally serve as a connection point to another structure, or as the connection between adjacent unit cells 12 and/or subarrays 18 when configured with multiple sections, as discussed above. According to one example, where array 10 is installed on a vehicle, such as a land-based vehicle, aircraft, or the like, ground plane 26 may represent an outer surface of that vehicle. According to another aspect, ground plane 22 may be separate from but attached or otherwise connected to the plane on which array 10 may be installed.

Connector 40 may be any suitable connector as dictated by the desired implementation. As discussed further below, the modular array 10 is contemplated to have a balanced, differential feed, thus connector 40 may be a balanced connector 40. According to one aspect, connector 40 may be a press fit balanced connector which may be readily and commercially available. According to another aspect, balanced connector 40 may be a balanced wideband impedance transformer (BWIT). Connector 40 may be operable to connect array 10 to other components including, but not limited to, receivers, transmitters, transceivers, processors, or the like through any suitable connections as dictated by the desired implementation and as discussed further below.

According to one aspect, connector 40 may be any suitable connector operable to connect the antenna elements 14 and 16 to a differential feed input which may be upstream and/or remote from array 10, as dictated by the desired implementation. According to another aspect, connector 40 may be or include a differential feed input which may further include a positive and negative terminal operable to receive a differential signal. Further according to this aspect, connector 40 may allow of electrical connection between the positive terminal and the first feed line 20A and between the negative terminal and second feed line 20B, as discussed further herein. According to another aspect, connector 40 may be omitted with array 10 and/or antenna elements 14 and 16 connected directly to the feed input, as dictated by the desired implementation.

With reference to FIG.3, array 10 may include one or more overlaps 42 which may be layered to form a radome/superstrate stackup 44 as dictated by the desired implementation. Overlaps 42 may include multiple layers, such as layers 42A, 42B, and 42C, consisting of any suitable materials. According to one aspect, overlaps 42 may include RF frequency transparent materials, or may include materials chosen for visual security and/or improved matching features, or any combination of these or other suitable materials. For example, overlaps 42 may have one or more layers of copper, Rogers 3003, BondPly, or other similar commercially available materials.

Radome/superstrate stackup 44 may be a protective covering that may fit over array 10 to protect the array 10 and components thereof from the exterior environment. Radome/superstrate stackup 44 may be constructed of any suitable material according to the desired implementation and may further have any suitable shape appropriate therefore and may include overlap 42 layers along with any other suitable or desired materials as desired or as dictated by the desired implementation. In implementations wherein it is beneficial to have overlaps 42 and/or a radome/superstrate stackup 44 that is operable to enhance the function of array 10 and the components thereof, it is contemplated that array 10 would include all suitable components to effectuate the same. For example, where overlaps 42 and/or radome/superstrate stackup 44 is expected to enhance the function of array 10, array 10 may include any suitable electrical connections therewith to accomplish this functionality.

Although not specifically described herein, other elements and components for necessary operation of array 10 are understood to be present. By way of one non-limiting example, array 10 may be understood to include all suitable electrical connections, including connections to associated receivers, transmitters, signal processors, or other similar components and systems, as necessary or desired.

As discussed above, array 10 and the components thereof are contemplated to be considered an all-metal fabrication without the use of PCBs or other materials. Accordingly, it is further contemplated that array 10 may be formed of a single conductive metal; however, it is recognized that known finishing processes may provide additional benefits that are not discussed herein. For example, a gold bath dip finish or the like may provide benefits beyond those described herein, or may enhance those benefits described herein. It is therefore expected that additional finishes explicitly fall within the scope of this disclosure where desirable.

Having thus described the elements and components of array 10, the theory of operation and the operation thereof will now be discussed.

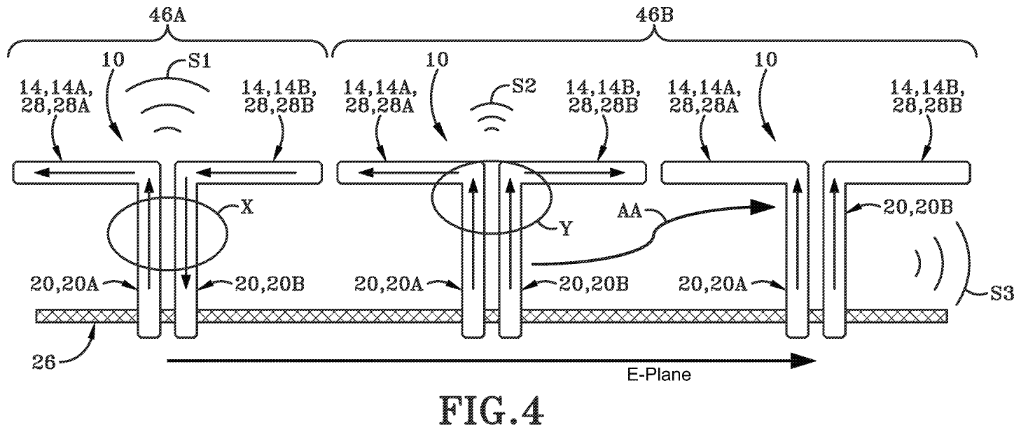

With reference to FIG.4, an illustration of E-plane scan resonance in differential feed lines is shown. Specifically, on the left is a balanced mode TCDA, such as the present modular array 10, having a differential wherein the signal (represented by the circled arrows X superimposed over the antenna elements 14A and 14B and feed lines 20 thereof) travels down one feed line 20 and up the other feed line 20 and thus travels in opposite)(180° directions. This is the basis for the balanced mode as a balanced signal is understood to have opposing directions. One shortcoming of using a typical differential feed is the excitation of common-mode (CM) resonance when scanning in the E-plane over an ultra-wideband (UWB) frequency range. This CM resonance can result in signal to become unbalanced and travel in the same direction through the feed lines of an element and may further cause signal degradation, reduced antenna efficiency, and interference with adjacent elements.

In particular, in FIG.4, a balanced mode TCDA is indicated at reference 46A (with the present array 10 is used as the exemplary balanced mode TCDA). At reference 46A, the present array 10 shows a strong signal, illustrated by the curved lines S1 radiating from the dipoles 28 of elements 14 and 16. If the E-plane resonances are not addressed, the signal can degrade and the feed lines 20 can radiate the signal out to neighboring elements in a process known as coupling (where the signal causes neighboring elements in the same array to interfere with the signals being broadcast and/or received by the array), which is shown by arrow AA in FIG.4. As further seen in FIG.4 at reference 46B, the signal S2 radiating from the dipoles 28 is reduced while the signal in further being resonated out from the feed lines 20 (as indicated at signal S3). Further seen at reference 46B, the signal traveling through the feed lines 20 is now moving in the same direction (represented by the circled arrows Y superimposed over the feed lines 20) which is the main cause of the coupling and feed line radiation of signal S3.

The inclusion of shorting arms 34 can prevent coupling and resonance between neighboring elements to maintain the balanced mode while using a differential feed, without the need for a balun or other additional equipment.

Accordingly, in operation, each unit cell 12 (and/or subarray 18) may have orthogonally-aligned antenna elements 14 and 16. Specifically, as discussed previously herein, each unit cell 12 may have one v-pol antenna element 14 and one h-pol antenna element 16, while subarrays 18 may have a plurality of each. Each element 14 and 16 may have a first and second arm (e.g. 14A and 14B) with the feed lines 20 that are connected to the dipoles 28. As used herein with regards to the operation of array 10, component previously discussed as part of elements 14 and 16 may be referenced as ‘A’ or ‘B’, for example dipole 28A or 28B. This nomenclature is understood to refer to the particular component's placement on first or second arms (e.g. 14A and 14B) of the particular element 14 or 16 and not as a limitation thereof. Further, as discussed above, references to element 14, and/or arms 14A and 14B are understood to be equally applicable to element 16 and/or arms 16A and 16B unless specifically stated otherwise. References to element and arms 14, 14A, 14B are made for simplicity and clarity and not for limiting disclosure thereof.

Each antenna element 14, 16 may then include and antenna input, which may be, or may be communicated through, connectors 40, as dictated by the desired implementation. The antenna input may receive signals from an input source that are 180° in phase. Operatively, a signal travels up the feed line 20A of the first arm 14A and then travels down the feed line 20B of the second arm 14B. The signal input from the input source may an analog signal. In one particular embodiment, the signal is an analog radio frequency (RF) signal.

Feed lines 20 may be simple twin feed lines composed of the feed line 20A of the first arm 14A and feed line 20B of the second arm 14B. A lower end of the feed line 20A of first arm 14A may be coupled with a positive input terminal of an input source (through connector 40) and to a lower end of the feed line 20B of second arm 14B, which may be coupled with a negative input terminal of the input source.

In continued operation, the shorting arms 34A and 34B may be considered as common mode mitigation elements that are configured to short part of the signal moving through the dipoles 28A and 28B of first and second arms 14A and 14B, respectively. Specifically, the first ends 36A and 36B of the shorting arms 34A and 34B are connected to the dipoles 28A and 28B, and the second ends 38A and 38B of shorting arms 34A and 34B are conductively connected to the ground plane 26.

Thus, according to one example, the signal travels from the positive input terminal through the feed line 20A of first arm 14A and to the dipole 28A. The signal will then be shorted to ground 26 via the shorting arm 34A. By shorting the signal from the dipole 28A into the ground plane 26, this is able to eliminate CM resonance from the dipole 28.

By way of additional background, the difference between the FUSE array and the present disclosure include the elimination of the single ended feed and replacement with a differential feed. This further allows for the elimination of a balun, which is included in the FUSE array. Another distinction between the present disclosure and the FUSE array is that the present disclosure shorts both dipoles 28 to the ground plane 26 while the FUSE array has one arm connected to the ground plane while the other arm thereof is insulated from the ground plane using a dielectric sleeve.

The difference between the PUMA array and the present disclosure includes that the subarray configuration and all-metal design of the present disclosure, as discussed above. Specifically, the PUMA array utilizes PCB technology that is built like a multiple layer configuration with holes drilled therethrough. Because of its configuration, the PUMA array can only achieve a 3 to 1 ratio from frequency high to frequency low, whereas the configuration of the present disclosure is able to achieve a 9 to 1 ratio from frequency high to frequency low. Another distinction between the present disclosure and the PUMA array is that the present disclosure antenna uses differential feeds with both of the dipoles being shorted to the ground plane. This is in further distinction to the PUMA array that, like the FUSE array, uses a single input feed with a balun.

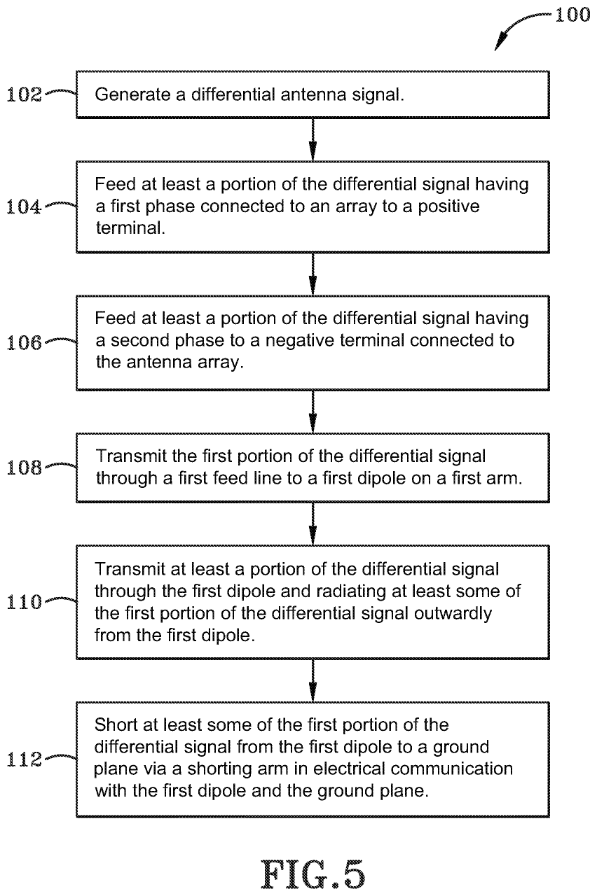

FIG.5 depicts an exemplary method of operation for the array 10 of the present disclosure generally reference as process 100. Process 100 may first include generating a differential antenna signal, shown generally at 102. Once the signal is generated, at least a portion of the differential signal may be fed to a positive terminal connected to at least one antenna element 14 and/or 16 of array 10. At the positive terminal, the differential signal may have a first phase. The step of feeding the signal to the positive terminal is shown generally at 104.

Process 100 may further include feeding at least a portion of the differential signal having a second phase to a negative terminal connected to at least one antenna element 14 and/or 16 of array 10. Feeding the signal to the negative terminal is shown generally at 106. According to one aspect, the second phase of the signal at the negative terminal may be 180° opposite the first phase at the positive terminal.

Next in process 100, the differential signal may be transmitted through the feed line 20A to the dipole 28A, shown generally at 108. Once the differential signal reaches the dipole 28A, at least some of the signal may be radiated outwardly from the dipole 28A, shown generally as step 110. Simultaneously, at least some (i.e., at least a portion) of the differential signal from the dipole 28A may be shorted to the ground plane 26 to mitigate common mode resonance in the array 10. The shorting of at least some of the signal may be accomplished by a common mode mitigation element (i.e. shorting arms 34) that is in electrical communication with the dipole 28A and the ground plane 26. The shorting of at least some of the signal to the ground plane 26 is shown generally at reference 112.

As described herein, array 10 and the operation thereof allows for mitigating common mode resonance from differential input signals without a balun using an all-metal modular array that is scalable, has increased bandwidth, a lower manufacturing lead time and manufacturing cost, and an increased compatibility with modern DPA systems.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non- transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer- readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer- centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0. % of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open- ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A modular antenna unit comprising:
a differential feed input operable to receive a differential signal;
at least one antenna element having a first arm and a second arm;
a first differential feed line having a first end in electrical connection with a first dipole on the first arm and a second end in electrical connection with the differential feed input;
a second differential feed line having a first end in electrical connection with a second dipole on the second arm and a second end in electrical connection with the differential feed input;
a common ground plane;
a first shorting arm having a first end in electrical connection with the first dipole on the first arm and a second end in electrical connection with the common ground plane; and
a second shorting arm having a first end in electrical connection with the second dipole on the second arm and a second end in electrical connection with the common ground plane, wherein the first and second shorting arms are adapted to short a portion of the differential signal from the first and second dipoles to the common ground plane.

2. The modular antenna unit of claim 1 wherein the at least one antenna element further comprises:
a first antenna element having a first arm and a second arm; and
a second antenna element having a first arm and a second arm.

3. The modular antenna unit of claim 2 wherein the first antenna element further comprises:
a vertically polarized antenna element.

4. The modular antenna unit of claim 3 wherein the second antenna element further comprises:
a horizontally polarized antenna element, wherein the second antenna element is arranged orthogonally to the first antenna element.

5. The modular antenna unit of claim 2 wherein the antenna unit further comprises:
a plurality of unit cells with each cell of the plurality of unit cells having a first antenna element and a second antenna element.

6. The modular antenna unit of claim 5 wherein the plurality of unit cells are adjoined by the common ground plane.

7. The modular antenna unit of claim 1 wherein the at least one antenna element, first and second feed lines, ground plane, and first and second shorting arms are formed from a single continuous piece of material.

8. The modular antenna unit of claim 7 wherein the single continuous piece of material further comprises:
a conductive metal surface.

9. The modular antenna unit of claim 7 wherein the single continuous piece of material is 3-D printed.

10. The modular antenna unit of claim 1 further comprising:
at least one overlap layer further defining a radome.

11. The modular antenna unit of claim 10 wherein the at least one overlap layer further comprises:
a plurality of overlap layers further defining the radome.

12. A method comprising:
generating a differential antenna signal; feeding a first portion of the differential signal having a first phase to a positive terminal on an antenna element of a modular antenna unit, wherein the modular antenna unit does not include a balun;
feeding a second portion of the differential signal having a second phase that is opposite of the first phase to a negative terminal on the antenna element of the modular antenna unit;
transmitting at least some of the differential signal through a feed line to a dipole on the antenna element and radiating the at least some of the differential signal outwardly from the dipole; and
mitigating common mode resonance in the modular antenna unit with a shorting arm in electrical connection with the dipole and the ground plane.

13. The method of claim 12 wherein mitigating common mode resonance further comprises:
shorting at least some of the differential signal from the dipole to a ground plane via the shorting arm.

14. The method of claim 12 wherein feeding the first and second portions of the differential signal to an antenna element further comprises:
feeding the first portion of the differential signal having the first phase to a positive terminal on a plurality of antenna elements of a modular antenna unit; and
feeding the second portion of the differential signal having the second phase to a negative terminal on the plurality of antenna elements of a modular antenna unit.

15. The method of claim 14 wherein the plurality of antenna elements are electrically connected to the ground plane.

16. The method of claim 15 wherein mitigating common mode resonance in the modular antenna unit further comprises:
mitigating common mode resonance in the modular antenna unit with a shorting arm in electrical connection with a dipole on each of the antenna elements of the plurality of antenna elements and the ground plane.

17. The method of claim 16 wherein mitigating common mode resonance further comprises:
shorting at least some of the differential signal from the dipole on each of the antenna elements of the plurality of antenna elements to the ground plane via the shorting arm.

18. The method of claim 12 further comprising:
forming the modular antenna unit from a single continuous piece of material.

19. The method of claim 18 wherein forming the modular antenna unit further comprises:
forming the modular antenna unit from a single continuous piece of conductive metal material.

20. The method of claim 18 wherein forming the modular antenna unit further comprises:
3-D printing the modular antenna unit from a single continuous piece of conductive metal material.
